(19) United States
(12) Patent Application Publication
(10) Pub. No.: US 2014/0022959 A1
(43) Pub. Date: Jan. 23, 2014

(54) TRANSMITTER, RECEIVER AND METHOD FOR ESTIMATING VARIABLE FRAME STRUCTURE USING PREAMBLE SIGNALS

(71) Applicant: Electronics and Telecommunications Research Institute, Daejeon-si (KR)

(72) Inventors: Eu-Suk SHIM, Gyeonggi-do (KR); Young-Il KIM, Daejeon-si (KR); Won RYU, Daejeon-si (KR)

(73) Assignee: Electronics and Telecommunications Research Institute, Daejeon-si (KR)

(21) Appl. No.: 13/945,451

(22) Filed: Jul. 18, 2013

(30) Foreign Application Priority Data
Jul. 19, 2012 (KR) 10-2012-0078939

(51) Int. Cl. H04W 72/04

(52) U.S. Cl. CPC H04W 72/0446
USPC 370/280; 370/328

(57) ABSTRACT

A transmitter for estimating a variable frame structure using preamble signals is provided, and the transmitter includes a subcarrier location modulator configured to modulate locations of subcarriers into predetermined locations based on information about a variable frame structure in an attempt to transmit preamble signals; and an Inverse Fast Fourier Transform (IFFT) unit configured to perform IFFT on the preambles carried on the subcarriers of which locations are modulated and wirelessly transmit the preamble signals on which IFFT has been performed.

### CROSS-REFERENCE TO RELATED APPLICATION

This application claims the benefit under 35 U.S.C. §119(a) of Korean Patent Application No. 10-2012-0078939, filed on Jul. 19, 2012, the entire disclosures of which are incorporated herein by references for all purposes.

### BACKGROUND

1. Field

The following description relates to a mobile communication system, and more particularly to a transmitter, a receiver and a method for estimating a frame structure using a signal received from a mobile communication base station in the Orthogonal Frequency Division Multiple (OFDM) mobile communication system.

2. Description of the Related Art

In the OFDM mobile communication system, data is transmitted on a frame basis. An OFDM Time Division Duplex (TDD) frame structure of the Wireless Broadband (WiBro) system consists of a Downlink (DL) frame and an Uplink (UL) frame. The DL frame indicates a connection from a base station to a mobile communication terminal, and the UL frame denotes a connection from a mobile communication terminal to a base station. In addition, each DL frame and UL frame is divided into smaller parts. For example, the DL frame is divided into a preamble, a DL sub-frame and an UL sub-frame. In other words, the TDD is a duplexing scheme for dividing a wireless channel into different time slots to operate a forward link for a predetermined frame period and a backward link for the rest frame period. The frame structure has a fixed DL/UL ratio of 29:18, a ratio defined by the IEEE 802.16j standard. However, variable types of a frame structure can be allocated for performance improvement, taking into consideration of a channel's features and a user's QoS requirements. To this end, variable information about a DL sub-frame and an UL sub-frame of one frame is transmitted via DL-MAP and UL-MAP in the IEEE 802.16e communication system.

The MAP information transmitted from a base station is acquired on a MAC layer of a receiver such as a mobile communication terminal. It means that the MAP information has to pass through elements of a physical layer of the receiver. Therefore, it takes long time to acquire the MAP information on the MAC layer of the receiver.

### SUMMARY

The following description relates to a transmitter, a receiver and a method for estimating variable frame structure using preambles to instantly acquire information about the variable frame structure.

In one general aspect of the present invention, a transmitter for estimating a variable frame structure using preamble signals is provided, the transmitter includes a subcarrier location modulator configured to modulate locations of subcarriers transmitting preamble signals into predetermined locations based on information about a variable frame structure in an attempt to transmit the preamble signals; and an Inverse Fast Fourier Transform (IFFT) unit configured to perform IFFT on the preamble signals carried on the subcarriers of which locations are modulated, and wirelessly transmit the preamble signals on which IFFT has been performed.

In another general aspect of the present invention, a receiver for estimating a variable frame structure using preamble signals is provided, and the receiver includes a variable Time Division Duplex (TDD) estimator configured to receive preamble signals using subcarriers on modulated locations, and acquire information about a variable frame structure of a current frame from the preamble signals; and a subcarrier location demodulator configured to demodulate the locations of the subcarriers output from the variable TDD estimator to acquire a cell identification (ID).

In another general aspect of the present invention, a transmission method for estimating a variable frame structure using preamble signals is provided, the transmission method includes modulating locations of subcarriers into predetermined locations based on information about a variable frame structure in an attempt to transmit preambles; and performing IFFT on preamble signals carried on the subcarriers of which locations are modulated, and wirelessly transmitting the preamble signals on which IFFT has been performed.

In another general aspect of the present invention, a reception method for estimating a variable frame structure using preamble signals is provided, and the reception method includes receiving preamble signals using subcarriers on modulated locations and acquiring information about a variable frame structure of a current frame from the preamble signals; and demodulating the modulated locations of the subcarriers output from a variable TDD estimator and acquiring a cell ID.

### BRIEF DESCRIPTION OF THE DRAWINGS

FIG. 1 is a diagram illustrating a structure of an IEEE 802.16j transmission frame in which a replay is applied based on the IEE 802.16 standard;

FIG. 2 is a diagram illustrating an interior configuration of a receiver for acquiring MAP information;

FIG. 3 is a diagram illustrating an example of a structure of an OFDM/OFDMA segment for transmitting preambles;

FIG. 4 is a graph illustrating a probability of failure of integer frequency offset estimation;

FIG. 5 is a conceptual view illustrating subcarrier location modulation according to an exemplary embodiment of the present invention;

FIG. 6 is a diagram illustrating OFDM transmitter and/or receiver according to an exemplary embodiment of the present invention;

FIG. 7 is a diagram illustrating a method for transmitting information about a variable frame structure using preambles according to an exemplary embodiment of the present invention; and

FIG. 8 is a flow chart illustrating a method for transmitting information about a variable frame structure using preambles according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will be suggested to those of ordinary skill in the art. Descriptions of well-known functions and structures are omitted to enhance clarity and conciseness.

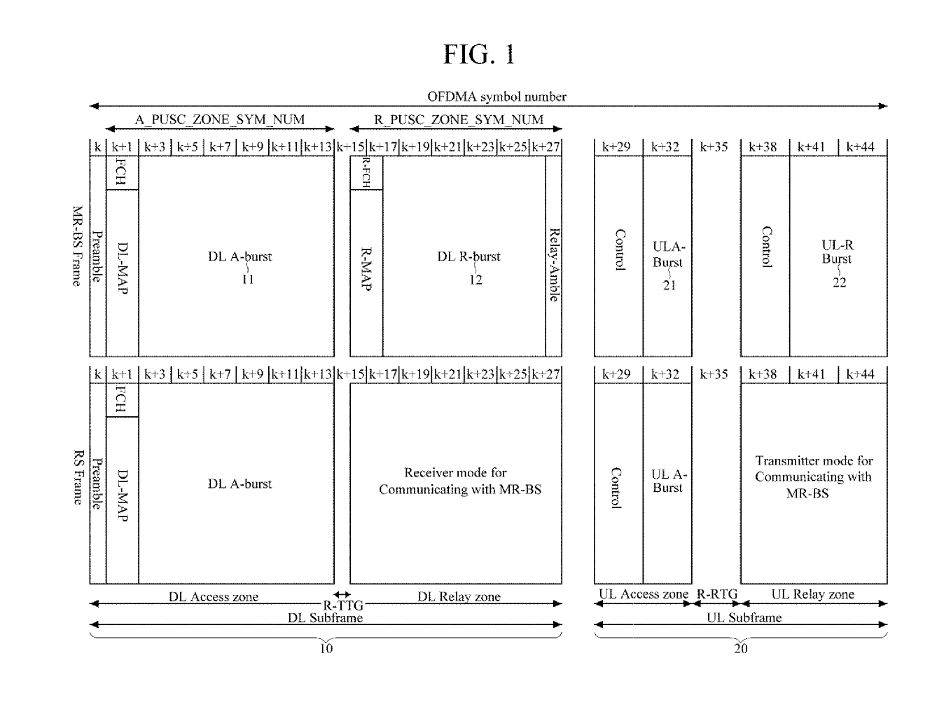

FIG. 1 is a diagram illustrating a structure of an IEEE 802.16j transmission frame in which a replay is applied based on the IEE 802.16 standard.

Referring to FIG. 1, a Time Division Duplex (TDD) scheme is employed in the structure of a transmission frame, and the TDD scheme is to divide a wireless channel into different time slots so as to operate a forward link for a predetermined frame period and a backward link for the rest frame period. Therefore, the transmission frame structure in which a relay is applied based on the IEEE 802.16j may be divided into a Down Link (DL) sub-frame 10 and an Up Link (UL) sub-frame 20. At this time, the DL sub-frame 10 has a transmission direction from a base station to a mobile communication terminal while the UL sub-frame 20 has a transmission direction from a mobile communication terminal to a base station. Furthermore, the DL sub-frame 10 is divided into an access section 11 and a replay section 12 while the UL sub-frame 20 is divided into an access section 21 and a replay section 22.

The frame structure shown in FIG. 1 has a fixed DL/UL ratio of 29:18 which is defined by the IEEE 802.16j standard. However, variable types of a frame structure may be allocated for performance improvement, taking into consideration a channel's features and a user's QoS requirements. To this end, in the IEEE 802.16e standard-based communication system, variable information about each of the DL sub-frame and the UL sub-frame is contained in DL-MAP and UL-MAP, respectively, and then transmitted.

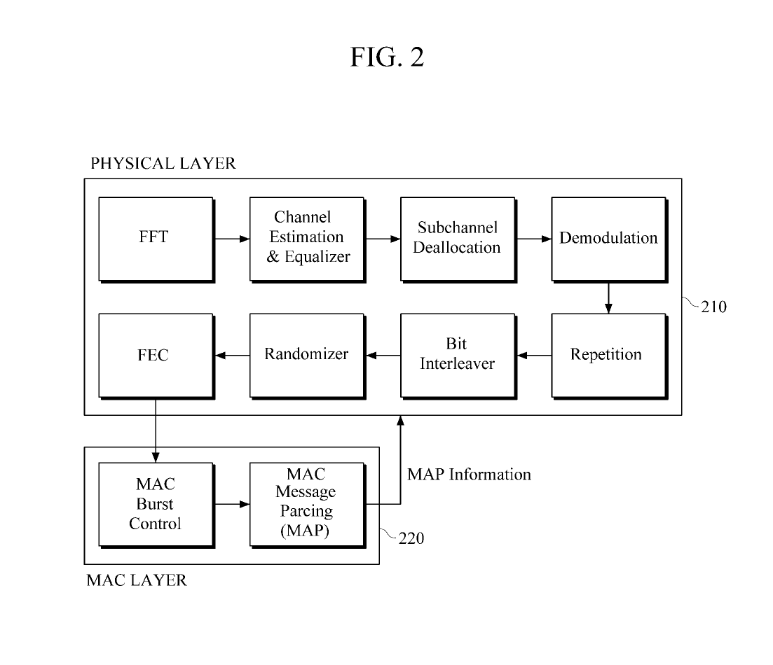

FIG. 2 is a diagram illustrating an interior configuration of a receiver for acquiring MAP information.

Referring to FIG. 2, a receiver, such as a mobile communication terminal, is composed of a physical layer 210 and a MAC layer 220. The MAP information transmitted from a base station should pass through elements of the physical layer 210 of FIG. 2 and then acquired on the MAC layer 220. In short, it takes a long time to acquire the MAP information on the MAC layer 220 since the MAP information should pass through the physical layer 210.

In addition, the MAP information acquired on the MAC layer 220 has to be reversely transmitted to the physical layer 210, so that a symbol which is to be used on the physical layer 210 may be acquired using the MAP information. Therefore, after a frame is received, it takes a considerable amount of time to acquire information about the current variable frame structure and then use the acquired information on the physical layer 210.

In order to solve the above problem, the present invention transmits information about a variable frame structure using preamble signals, rather than using the DL-MAP. That is, as information about a variable frame structure is transmitted using preamble signals, it is able to instantly acquire information about each sub-frame of a variable frame since the preamble is allocated to the first symbol of a DL frame.

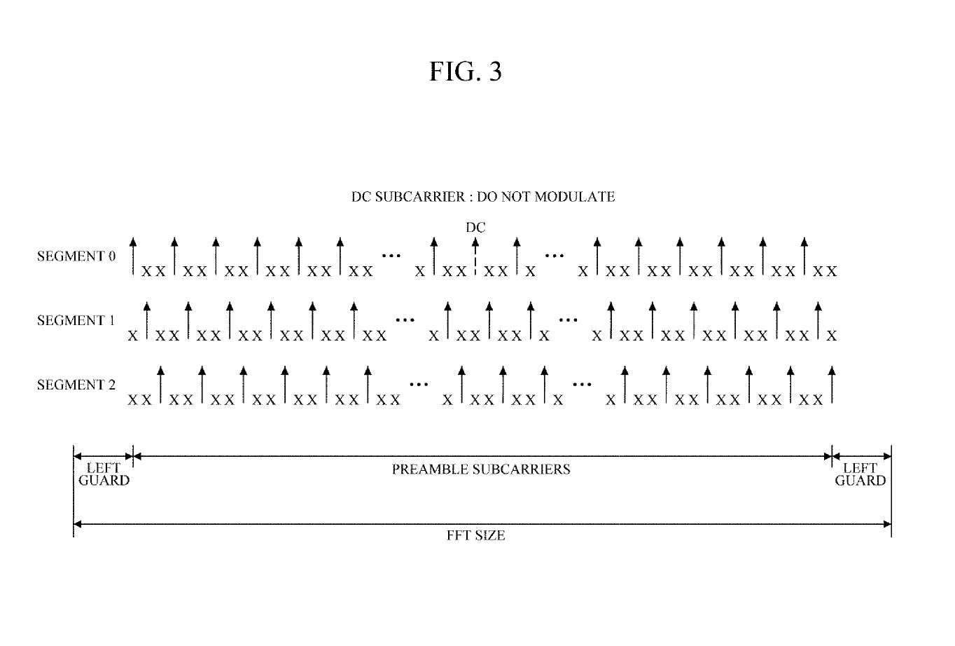

FIG. 3 is a diagram illustrating an example of a structure of an OFDM/OFDMA segment for transmitting preambles.

A preamble is allocated to the first symbol of a DL sub-frame. At this time, the preamble includes segment number information and a cell identification (ID), which is necessary to identify a cell of the mobile communication system. Using the preamble, a mobile communication terminal may identify a cell and establish connection to a corresponding base station.

Referring to FIG. 3, guard bands are arranged on the left-hand and right-hand sides of a plurality of DC subcarriers to prevent any interruption of adjacent frequency bands. At this time, each of a plurality of DC subcarriers is a null subcarrier. In addition, the subcarriers of a segment are spaced apart at predetermined intervals from one another (for example, three notches in FIG. 3). Due to this configuration, the base station is able to transmit a signal including preamble information corresponding to a cell ID using an allocated segment. Accordingly, the mobile communication terminal may identify a preamble index corresponding to a preamble signal using the signal received from the base station, so that a cell ID and a segment number of the base station may be informed of the mobile communication terminal.

Although a mobile communication system having three OFDMA/OFDM segments is described herein as an example, those skilled in the art understand that the apparatus and the method for searching for a cell according to exemplary embodiments of the present invention are not limited thereto, considering various mobile communication systems and mobile communication standards that are complied with by the mobile communication systems.

According to an exemplary embodiment of the present invention, the above-described structure of a preamble is modified in a proper manner to transmit information about a variable frame structure. As the information about the variable frame structure is transmitted using the preamble, the information about the variable frame structure may be acquired on a physical layer of a mobile communication terminal, before the DL-MAP and the UL-MAP are demodulated.

Generally, segment information is the first demodulated information in the information transmitted using preamble signals. The segment information is estimated based on data size included in subcarrier location information. The segment information is used for estimating a time synchronization offset and a frequency synchronization offset, while the subcarrier location information is used for estimating an integer frequency offset. Considering the number of subcarriers which are generally used for estimating an integer frequency offset, the segment information may be estimated using only some of subcarriers included in each set of subcarriers.

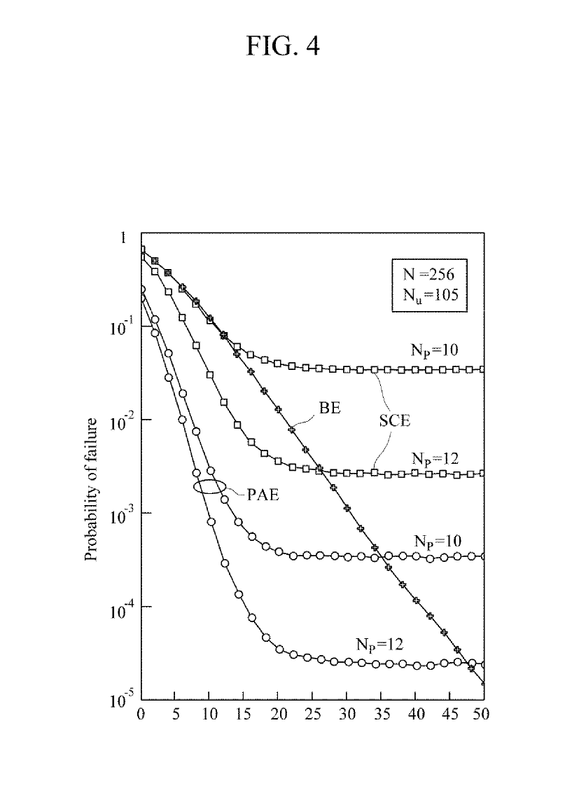

FIG. 4 is a graph illustrating a probability of failure of integer frequency offset estimation.

As shown in FIG. 4, if a proper scheme for estimating an integer frequency offset is employed, twelve pilots are enough to yield decent performance. In the case of a preamble structure defined by IEEE 802.16e system, 568, 284, 142 and 36 subcarriers may be used to estimate an integer frequency offset when the FFT window size is 2048, 1024, 512 and 128, respectively. It means that an integer frequency offset and a segment number may be estimated properly even though all the subcarriers are not used.

Therefore, the present invention transmits information about a variable frame structure by shifting locations of some of subcarriers included in a subcarrier set.

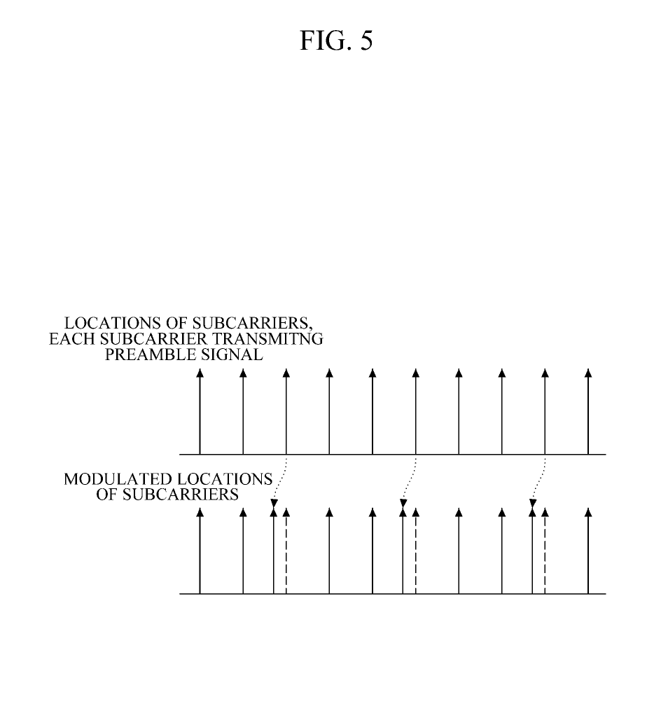

FIG. 5 is a conceptual view illustrating subcarrier location modulation according to an exemplary embodiment of the present invention.

Referring to FIG. 5, locations of some of subcarriers, each carrying a preamble signal, are modulated. By modulating the locations of the subcarriers, information about a variable frame structure may be transmitted. Next, a receiver, which has received the preamble signals using the subcarriers on the shifted locations, may estimate the information about the variable frame structure based on the shifted locations of the subcarriers.

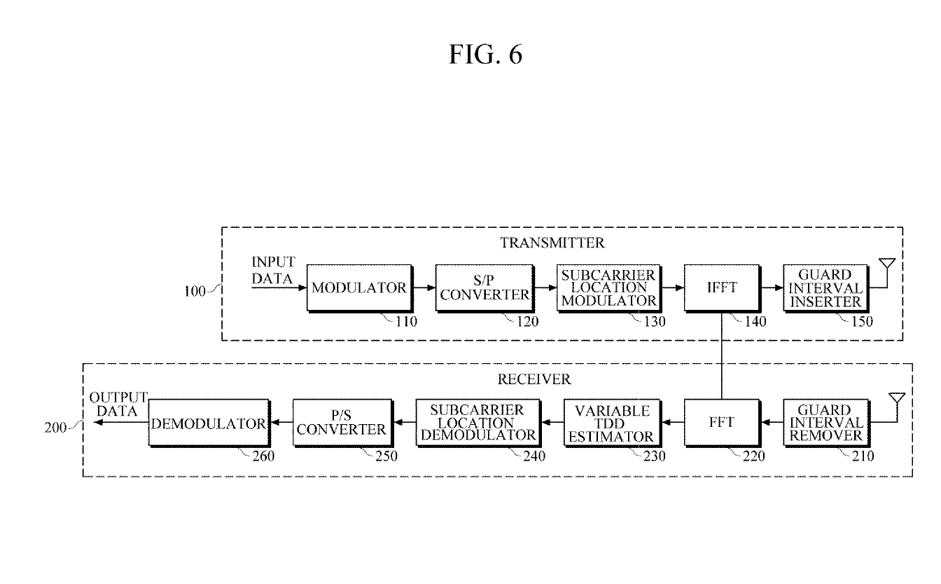

Hereinafter, detailed descriptions about FIG. 5 will be provided with reference to FIGS. 6 to 8.

FIG. 6 is a diagram illustrating OFDM transmitter and/or receiver according to an exemplary embodiment of the present invention.

Referring to FIG. 6, the OFDM transmitter includes a modulator 110, a Serial/Parallel (S/P) converter 120, a subcarrier location modulator 130, an Inverse Fast Fourier Transform (IFFT) unit 140 and a guard interval inserter 150.

In addition, the OFDM receiver includes a guard interval remover 210, a Fast Fourier Transform (FFT) unit 220, a variable Time Division Duplex (TDD) estimator 230, a subcarrier location demodulator 240, a Parallel/Serial (P/S) converter 250 and a demodulator 260.

According to an exemplary embodiment of the present invention, the subcarrier location converter 130, the variable TDD estimator 230 and the subcarrier location demodulator 240 are further included in order to shift locations of subcarriers with little affect on a frame structure generated based on an IEEE 802.16 standard. In other words, they are required to minimize a change in the existing preamble structure and the physical layer. Therefore, additional information (that is, information about a variable frame) may be transmitted simply by adding required elements to the transmitter and/or receiver, instead of changing the existing preamble structure and/or receiver. Other elements are commonly used in general OFDM transmitter and/or receiver, so relevant detailed descriptions will not be provided herein.

With reference to FIG. 6, input data are data transmitted from an upper MAC layer and refers to an input signal determined according to a cell ID and a segment number.

The subcarrier location modulator 130 modulates locations of subcarriers with respect to data which has passed through the modulator 110 and the S/P converter 120. Specifically, the subcarrier location modulator 130 modulates locations of some of allocated subcarriers as shown in FIG. 6 and additionally transmits information about the variable frame structure based on the modulated locations of the subcarriers. At this time, data size is maintained when the subcarrier locations are being modulated.

As locations of subcarriers are different in each segment, the locations of the subcarriers are modulated in a manner that a running index of physical locations of the subcarriers is shifted by between +2 and −2, thereby making the locations of the subcarriers identical in every segment.

For example, suppose that a variable TDD DL sub-frame and a variable TDD UL sub-frame of the current frame have 31 symbols and 16 symbols, respectively, and that a running index of 1, 2, 3, 4, 5, 6 and 7 is shifted by −1 in segment 0. In segment 0, referring to FIG. 5, the sub-frame location modulator 130 shifts the running index of physical locations of the first, sixth, ninth, twelfth, fifteenth, eighteenth and twenty-first subcarriers by one notch to the left whereby the second, fifth, eighth, eleventh, fourteenth, seventeenth and twentieth subcarriers may carry preamble information. Preamble signals carried on the subcarriers of which locations are modulated are wirelessly transmitted via the IFFT 140 and the guard interval inserter 150.

At this time, the subcarrier location modulator 130 includes a subcarrier location modulation mapping table that is based on a variable frame structure commonly available in a receiver. Based on the mapping table, the subcarrier location modulator 130 modulates the locations of the subcarriers into locations mapped to information about the variable frame structure.

Next, the receiver 200 receives preamble signals using the subcarriers on the modulated locations. The variable TDD estimator 230 acquires the information about the variable frame structure of the current frame from the preamble signals that have passed through the guard interval remover 210 and the FFT 220.

Since specific subcarriers which may be affected by the subcarrier location modulator 130 are informed in advance, the variable TDD estimator 230 acquires the information about the variable frame structure which is additionally transmitted.

That is, the variable TDD estimator 230 acquires the information about the variable frame structure using the subcarrier location modulation mapping table that is based on a variable frame structure commonly available in a transmitter.

For example, if segment information is acquired and an integer frequency offset is compensated simultaneously, information about a variable frame structure may be acquired based on modulated locations of subcarriers. That is, as information on subcarriers of which locations are modulated based on the information about the variable frame structure is informed in advance, sizes of data carried on all of the subcarriers are calculated and accumulated to acquire the information about the variable frame structure indicated by the biggest size of data.

The above may be represented by Equation 1.

$${T}_{index} = {max}_{i} {\sum }_{k ∈ I ( i )} Y ( k ) {Y}^{*} ( k ) , i = 0 , 1 , 2 , … , L - 1. \qquad 〈 Equation 1 〉$$

In Equation 1, I(i) is a group of subcarrier location indexes with respect to the i-th variable TDD, and Y(k) is data which have underwent FFT operation to be carried by the k-th subcarrier. Information about the current variable frame structure may be acquired using Equation 1. In order to estimate the variable frame structure, not only autocorrelation but also correlation may be performed on the current signal. Meanwhile, the correlation generally uses pilot information in order to estimate a cell ID.

Upon acquiring the information about the variable frame structure, the subcarrier location demodulator 240 demodulates the modulated subcarrier locations to acquire a cell ID. That is, the subcarrier location demodulator 240 restores the modulated subcarrier locations shown in FIG. 6 to be original subcarrier locations.

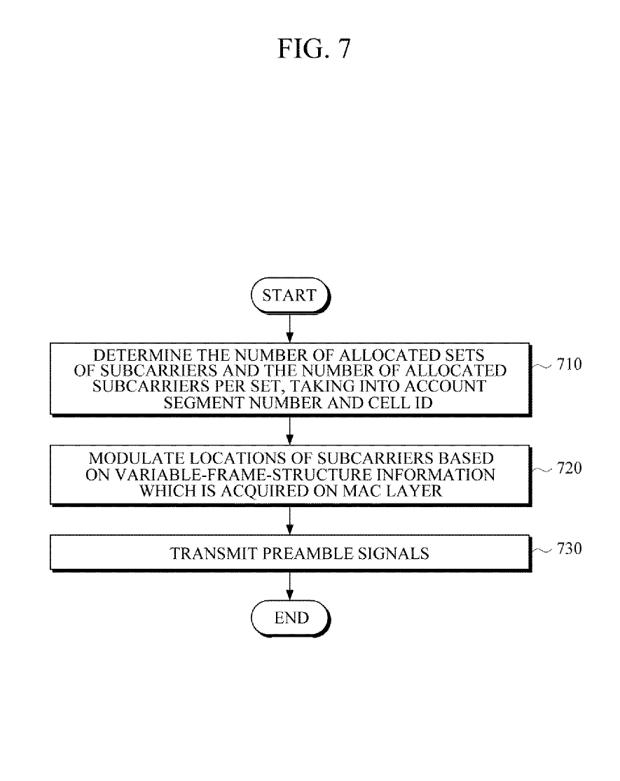

FIG. 7 is a diagram illustrating a method for transmitting information about a variable frame structure using preambles according to an exemplary embodiment of the present invention.

In 710, referring to FIG. 7, a transmitter determines the number of allocated sets of subcarriers and the number of allocated subcarriers per set, taking into account of a segment number and a cell ID.

In 720, the transmitter modulates locations of the subcarriers allocated in 710 based on information about a variable frame structure. That is, the transmitter includes a subcarrier location modulation mapping table that is based on a variable frame structure commonly available in a receiver and, based on the mapping table, the transmitter modulates the locations of the allocated subcarrier into locations mapped to the information about the variable frame structure. At this time, different locations of the subcarriers are used in each segment. Therefore, the locations of the subcarriers are modulated in a manner that a running index of physical locations of subcarriers is shifted by between +2 and −2, thereby ensuring that the subcarriers are placed at identical locations in every segment.

In 730, the transmitter wirelessly transmits preamble signals using the subcarriers on the modulated locations.

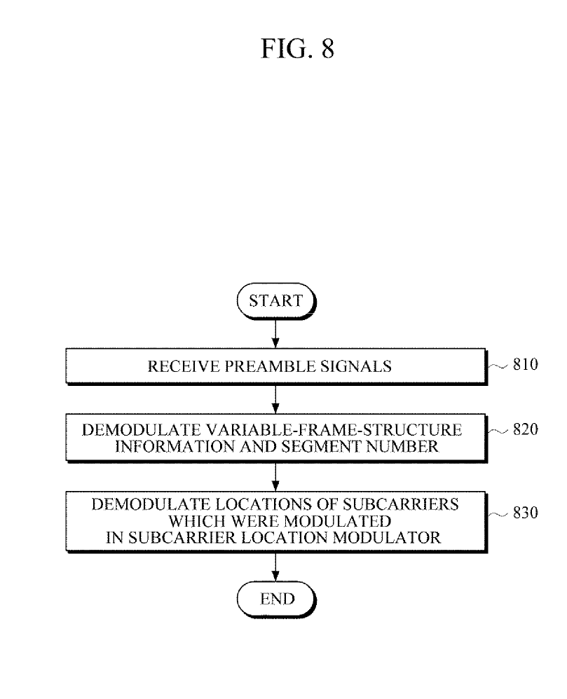

FIG. 8 is a flow chart illustrating a method for transmitting information about a variable frame structure using preambles according to an exemplary embodiment of the present invention.

In 810, referring to FIG. 8, the receiver receives wirelessly-transmitted preamble signals. The wirelessly-transmitted preamble signals are signals, each carried on each of subcarriers of which locations are modulated based on a predetermined variable frame structure.

In 820, the receiver acquires information about a variable frame structure of the current frame from the wirelessly-transmitted preamble signals. Since specific subcarriers which are able to be affected inside of the transmitter are informed in advance, the receiver acquires the additionally transmitted information about the variable frame structure by detecting the specific subcarriers That is, the receiver acquires the information about the variable frame structure using a subcarrier location modulation mapping table that is based on a variable frame structure commonly available in a transmitter.

If segment information is acquired and integer frequency offset is compensated simultaneously, the information about the variable frame structure may be acquired based on the modulated locations of the subcarriers. In other words, as information on subcarrier of which locations are to be modulated based on the information about the variable frame structure is informed in advance, sizes of data carried on all of the subcarriers are calculated and accumulated, so that the information about the variable frame structure indicated by the biggest size of data is acquired. The above may be represented by the above Equation 1.

In 830, the receiver demodulates the modulated locations of the subcarriers to acquire a cell ID. That is, the receiver restores the modulated subcarrier locations as shown in FIG. 6 to be original subcarrier locations.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A transmitter for estimating a variable frame structure using preamble signals, the transmitter comprising:
a subcarrier location modulator configured to modulate locations of subcarriers transmitting preamble signals into predetermined locations based on information about a variable frame structure in an attempt to transmit the preamble signals; and
an Inverse Fast Fourier Transform (IFFT) unit configured to perform IFFT on the preamble signals carried on the subcarriers of which locations are modulated, and wirelessly transmit the preamble signals on which IFFT has been performed.

2. The transmitter of claim 1, wherein the locations of the subcarriers are determined according to a cell ID and a segment number.

3. The transmitter of claim 1, wherein the subcarrier location modulator comprises a subcarrier location modulation mapping table that is based on a variable frame structure commonly used in a receiver, and modulates the locations of the subcarriers into locations mapped to the information about the variable frame structure.

4. A receiver for estimating a variable frame structure using preamble signals, the receiver comprising:
a variable Time Division Duplex (TDD) estimator configured to receive preamble signals using subcarriers on modulated locations, and acquire information about a variable frame structure of a current frame from the preamble signals; and
a subcarrier location demodulator configured to demodulate the locations of the subcarriers output from the variable TDD estimator to acquire a cell identification (ID).

5. The receiver of claim 4, wherein the variable TDD estimator acquires the information about the variable frame structure using a subcarrier location modulation mapping table that is based on a variable frame structure commonly available in a transmitter.

6. The receiver of claim 5, wherein the variable TDD estimator calculates sizes of data carried on all of the subcarriers, accumulates the calculated sizes of data, and acquires the information of the variable frame structure indicated by a biggest size of data from the subcarrier location modulation mapping table that is based on the variable frame structure commonly available in the transmitter.

7. The receiver of claim 4, wherein the variable TDD estimator performs auto-correlation on the current signal in an attempt to estimate the variable frame structure.

8. A transmission method for estimating a variable frame structure using preamble signals, the transmission method comprising:
modulating locations of subcarriers into predetermined locations based on information about a variable frame structure in an attempt to transmit preambles; and
performing IFFT on preamble signals carried on the subcarriers of which locations are modulated, and wirelessly transmitting the preamble signals on which IFFT has been performed.

9. The transmission method of claim 8, wherein the locations of the subcarriers are determined according to a cell ID and a segment number.

10. The transmission method of claim 8, wherein the modulating of the locations of the subcarriers comprises modulating the locations of the subcarriers into locations mapped to the information about the variable frame structure, using a subcarrier location modulation mapping table that is based on a variable frame structure commonly available in a receive.

11. A reception method for estimating a variable frame structure using preamble signals, the reception method comprising:
receiving preamble signals using subcarriers on modulated locations and acquiring information about a variable frame structure of a current frame from the preamble signals; and
demodulating the modulated locations of the subcarriers output from a variable TDD estimator and acquiring a cell ID.

12. The reception method of claim 11, wherein the acquiring of the cell ID comprises acquiring the information about the variable frame structure using a subcarrier location modulation mapping table that is based on a variable frame structure commonly available in a transmitter.

13. The reception method of claim 12, wherein the acquiring of the cell ID comprises calculating sizes of data carried on all of the subcarriers, accumulating the calculated sizes of data and acquiring information about the variable frame structure indicated by a biggest size of data from the subcarrier location modulation mapping table that is based on the variable frame structure commonly available in the transmitter.

14. The reception method of claim 11, wherein the acquiring of the cell ID comprises performing auto-correlation on a current signal in an attempt to estimate the variable frame structure.
